(19) United States
(12) Patent Application Publication
(10) Pub. No.: US 2016/0201830 A1
(43) Pub. Date: Jul. 14, 2016

(54) BEAD SEAL AND CONNECTION DEVICE COMPRISING SUCH A SEAL

(71) Applicant: PARKER HANNIFIN MANUFACTURING FRANCE SAS, Annemasse (FR)

(72) Inventor: Philippe Le Quere, Betton (FR)

(21) Appl. No.: 14/911,769

(22) PCT Filed: Aug. 20, 2014
(86) PCT No.: PCT/EP2014/067777

§ 371 Date: Feb. 12, 2016

(30) Foreign Application Priority Data
Aug. 21, 2013 (FR) 13 58109

(51) Int. Cl. F16L 21/03; F16J 15/06; F16J 15/02

(52) U.S. Cl. CPC F16L 21/03; F16J 15/022; F16J 15/062

(57) ABSTRACT

An annular sealing gasket (7) for a fluid flow coupling device (1), the gasket (7) having side faces (8, 9), an outer circumference (10) defined by an outer bead (11), and an inner circumference (13) defined by an inner bead (14) that joins at least one of the side faces (8, 9) via a frustoconical surface (15, 16) that is not tangential to the inner bead (14). A coupling device (1) including such an annular sealing gasket (7).

### FIELD OF THE INVENTION

The present invention relates to the field of sealing fluid transport circuits, and more particularly to sealing couplings for tubes, in particular quick connection couplings.

### STATE OF THE ART

Quick connection type coupling devices are known for connecting together two elements of a fluid transport circuit. By way of example, such an element may be a pump, a manifold, an actuator, a tank, a flow regulator, a pressure regulator, or indeed a tube.

A coupling device generally comprises a body having a bore made therein that is in fluid flow communication with one of the circuit elements and that receives means for retaining in sealed manner a tube that is to be coupled to said element. By way of example, the retaining means comprise an elastically deformable toothed washer together with an annular sealing gasket for ensuring sealed coupling between the bore and the tube for coupling thereto. Conventionally, the gasket is received in an annular groove formed in the bore, or it is merely pressed via one of its side faces against an abutment in the bore.

The annular gaskets used for such couplings are frequently circular in section and are known as “0-rings”. Such gaskets are obtained by molding using a mold having two recesses, each of which forms one half-torus of the gasket. Once the gasket has been molded, at the location of the junction between the recesses (also known as the parting plane) the gasket presents annular flash and possibly also an offset between the half-toruses relative to each other. Although in widespread use, such gaskets present the drawback of turning partially inside out while the tube is being inserted, thereby twisting the parting plane where leakage will take place.

In order to mitigate that drawback, proposals have been made to modify the section of the annular gasket. Gaskets have thus been designed with side faces that are flat and that extend radially, an outer circumference formed by a cylindrical surface, and an inner circumference having a rounded profile. The inner circumference is formed with a partially circular bead that joins the side faces of the gasket via frustoconical surfaces that are tangential to the circular bead. Such gaskets provide good sealing and enable the gaskets to be compressed progressively by the tube while it is being inserted. The force that needs to be exerted in order to compress the gasket is nevertheless relatively large. In order to make it easier to insert the tube into the gasket, it is known to grease the gasket in the factory when assembling together the components of the coupling. Nevertheless, too little grease or too much grease can lead to insufficient greasing of the gasket, which makes it difficult to insert the tube in the gasket, or can lead to pollution in the circuit. Certain specific applications (medical, agrifood, chemical, . . . ) require specific greases, thereby complicating the management of stocks for manufacturers and leads to very expensive inspections to ensure that greasing operations are in compliance.

### OBJECT OF THE INVENTION

An object of the invention is to propose a gasket making it possible to obviate at least in part the above-mentioned drawbacks.

### SUMMARY OF THE INVENTION

To this end, the invention provides an annular sealing gasket for a fluid flow coupling device. The gasket has side faces, an outer circumference defined by an outer bead of partially circular cross-section, and an inner circumference defined by an inner bead of partially circular cross-section and that joins at least one of the side faces via a frustoconical surface that is not tangential to the inner bead.

Thus, the non-tangential frustoconical surface enables the gasket to be compressed progressively and enables the tube to go past the inner bead more easily as a result of a reduction in the volume of elastic material that opposes insertion of the tube and that needs to be compressed.

In a particular embodiment, the outer bead joins each of the side faces via a cylindrical surface of generator line parallel to a central axis of the gasket.

This provision makes it possible to ensure sealing between the gasket and the bore in which it is mounted by compressing solely the outer bead, thereby contributing to reducing the volume of elastic material that opposes insertion of the tube and that needs to be compressed.

Advantageously, said frustoconical surface has a half angle at the apex lying in the range five degrees to twenty degrees, approximately, and that is preferably substantially equal to ten degrees.

Preferably, the sealing gasket has a cross-section that is symmetrical about a radial midplane of the gasket.

A gasket of section that is symmetrical about a radial axis serves to facilitate the operations of fabricating a coupling device incorporating it by avoiding any need to orient the gasket while it is being put into place.

The invention also provides a coupling device for a cylindrical tube, the coupling device comprising a bore, an annular sealing gasket as described above, and an abutment against which one of the side faces of the annular sealing gasket comes to bear.

Other characteristics and advantages of the invention appear on reading the following description of a particular, non-limiting embodiment of the invention.

### BRIEF DESCRIPTION OF THE DRAWINGS

Reference is made to the accompanying figures, in which:

FIG. 1 is a half-view in axial section of a device of the invention;

FIG. 2 is a half-view in axial section of a gasket in the embodiment of FIG. 1;

FIG. 3 is a diagram showing the FIG. 1 device while being inserted into a tube; and

FIG. 4 is a view analogous to the view of FIG. 3, the tube being fully inserted into the device.

### DETAILED DESCRIPTION OF THE INVENTION

The device of the invention in this example is a quick-connection coupling device having a section arranged to be in fluid flow communication with equipment of a fluid transport circuit and a section arranged to receive a tube 5 of the same fluid transport circuit and to couple the tube 5 and the equipment together.

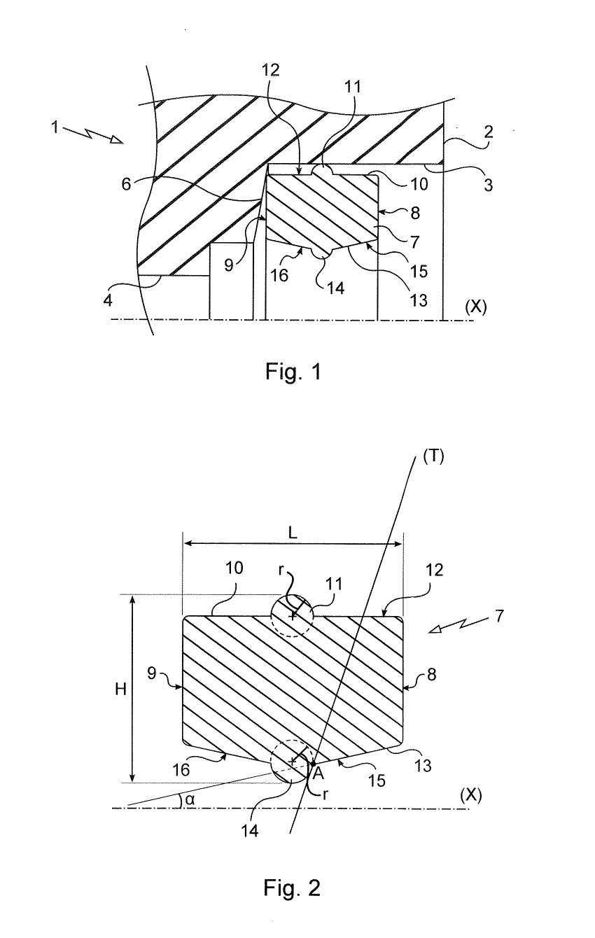

With reference to FIGS. 1 and 2, the coupling device, given overall reference 1, comprises a cylindrical body 2 of longitudinal axis X having a fluid flow communication bore 3 formed therein and a second bore 4 that joins the equipment to which the tube 5 is to be coupled, which tube is made of plastics material in this example.

The bore 3 presents a continuous annular shoulder 6 against which a sealing gasket 7 comes to bear. The means for retaining the tube 5 are not shown and may take various forms known to the person skilled in the art.

The gasket 7 is described below in detail.

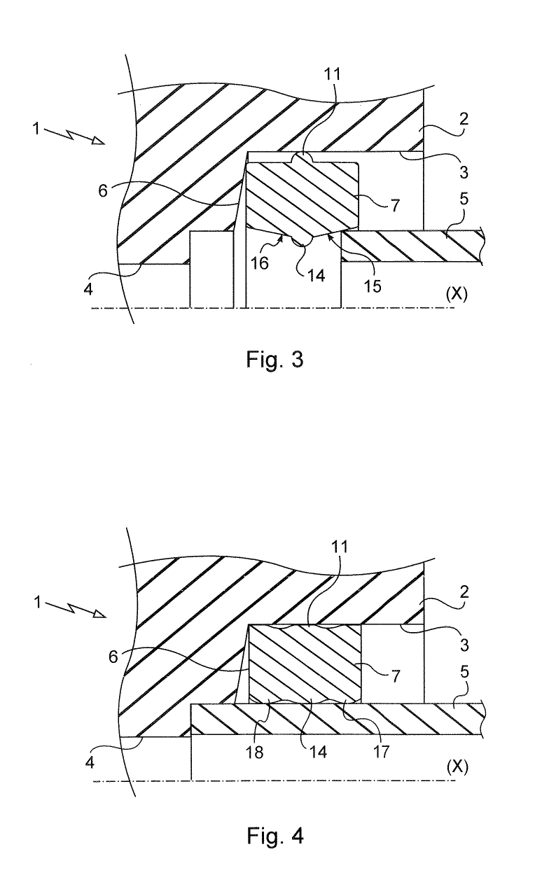

The gasket 7 is of annular shape having a central axis X, with two parallel side faces 8 and 9 that are substantially radial (the side face 8 bearing against the shoulder 6), an outer circumference 10, and an inner circumference 13. The outer circumference 10 is defined by an outer bead 11 of partially circular cross-section that joins each of the side faces 8 and 9 via a cylindrical surface 12 having a generator line parallel to the central axis X. The inner circumference 13 is defined by an inner bead 16 of partially circular cross-section and joins the side face 8 via a frustoconical surface 15 that is not tangential to the inner bead 14. The inner bead 14 also joins the side face 9 via a frustoconical surface 19 that is not tangential to the inner bead 14. In the meaning of the present description, and with reference to FIG. 3, the frustoconical surface 15, 16 is considered in simplified manner as being non-tangential to the inner bead 14 if it intersects the inner bead 14. In other words, the frustoconical surface 15, 16 is considered as being non-tangential to the inner bead 14 when a straight line belonging to the frustoconical surface 15, 16 and to an axial plane containing the axis X makes a non-zero angle with the tangent T to the circular portion of the inner bead 14 passing via the point of intersection A between the surface of the inner bead 14 and the frustoconical surface 16 in the axial plane under consideration. The frustoconical surfaces 15 and 16 are coaxial with the axis X.

The frustoconical surfaces 15 and 16 connecting the inner bead 14 to the side faces 8 and 9 of the gasket 7 have a half-angle at the apex □ that is substantially equal to 10° relative to an axial direction, in this example. It may be observed in FIGS. 1 to 3, that the inner and outer beads 14 and 18 present sections of areas that are substantially equal.

The device is described below in operation with reference to FIGS. 3 and 4. While inserting the plastics material tube 5 into the quick connection coupling device 1, the end of the tube 5 comes into contact with the frustoconical surface 15 and then exerts a compression force on the gasket 7 in a radial direction. Thus, as the tube 5 is being inserted into the gasket 7, it begins by compressing the outer bead 11 against the inside face of the bore 3, thereby providing sealing between the gasket 7 and the bore 3 at the outer circumference 10, and then the end of the tube 5 goes past the inner bead 14 by compressing it, which step represents the moment when the insertion force is the greatest. The compression of the bead 14 by the tube 5 makes it possible to achieve a sealing connection between the gasket 7 and the tube 5 at the inner circumference of the gasket 7. Once the tube 5 is fully inserted into the coupling 1, the gasket 7 adopts a deformed state as shown in FIG. 5. In this state, the deformation of the inner bead 14 has caused the frustoconical surfaces 15 and 16 to deform, thereby creating two annular compression zones 17 and 18 exerting a radial peripheral compression force on the tube 5. These radial peripheral forces exerted on two portions of significant width of the tube 5 combat ovalization of the tube, thereby contributing to the sealing performance of the gasket 7. The deformation of the tube 5 under the effect of movements perpendicular to the axis X is also reduced, which presents a significant advantage in movable systems where the tube 5 is moved, e.g. by handling arms.

The sealing provided by the gasket 7 is particularly effective when at least one of the beads 14 or 15 is of circular section with a radius r lying in the range H/4 to H/8, where H represents the thickness of the gasket 7 in a radial direction of the gasket 7. Best sealing is obtained for a value of the radius r that is substantially is equal to ⅙ of the thickness H.

In general manner, and in particular in applications of replacing an existing gasket for which the thickness L of the gasket in an axial direction is already determined, the radius r is ideally such that 6r<L<10r, and preferably substantially equal to ⅛ of the thickness L.

The section of the gasket 7 in this example is symmetrical about a radial midplane of the gasket 7 (this plane containing the radial axes of the gasket 7). This makes it possible to avoid paying attention to a particular orientation for the gasket 7 during assembly, thereby making it simpler to put the gasket 7 into place in the device 1 in automatic manner.

Naturally, the invention is not limited to the embodiment described but covers any variant coming within the ambit of the invention as defined by the claims.

In particular,
although in this example the tube that is connected to the quick connection coupling device of the invention is made of plastics material, the invention is equally applicable to tubes made of other types of material, such as steel, stainless steel, copper, composites, . . . ;
although in this example the two side faces of the gasket are parallel and substantially radial, the invention applies equally to a gasket having side faces that are not parallel and/or that extend in planes that form a non-zero angle relative to a radial plane. Finally, the side faces need not be plane and they could be frustoconical or include portions in relief such as for example an annular projection for co-operating with a groove, or studs enabling the gasket to be prevented from turning;
although in this example the frustoconical surfaces 15 and 16 between the inner bead 14 and the side faces 8 and 9 of the gasket 7 have a half-angle at the apex that is substantially equal to 10 degrees, the invention applies equally to other values for the half-angle at the apex, such as for example an angle lying in the range five degrees to twenty degrees;
although in this example the inner bead 14 and the outer bead 11 present cross-sections of areas that are substantially equal, the invention applies equally to a gasket possessing beads that present cross-sections of areas that are different, for example an outer bead 11 presenting a cross-section having an area greater than the area of the cross-section of the inner bead 14;
although in this example the two frustoconical surfaces 15 and 16 are shaped to act after the tube has been inserted to exert a radial peripheral compression force on the tube, the invention applies equally to a quick connection coupling device in which only one of the frustoconical surfaces 15, 16 is shaped to act after insertion of the tube to exert a radial peripheral compression force on the tube;
although in this example the section of the gasket is symmetrical relative to a radial axis, the invention applies equally to a gasket that is asymmetrical relative to a radial axis, such as for example a gasket that has only one frustoconical surface 15, 16; and
although in this example the gasket 7 is mounted in a coupling device of the quick connection type, the invention applies equally to a gasket mounted in other types of coupling device, such as for example devices with connection by screw fastening, brazing, or adhesive.

1. An annular sealing gasket for a fluid flow coupling device, the gasket having side faces, an outer circumference defined by an outer bead, and an inner circumference defined by an inner bead that joins at least one of the side faces via a frustoconical surface that is not tangential to the inner bead.

2. An annular sealing gasket according to claim 1, wherein the outer bead joins each of the side faces via a cylindrical surface of generator line parallel to a central axis of the gasket.

3. An annular sealing gasket according to claim 1, wherein said frustoconical surface has a half angle at the apex lying in the range five degrees to twenty degrees, approximately.

4. An annular sealing gasket according to claim 3, wherein the half-angle at the apex is substantially equal to ten degrees.

5. An annular sealing gasket according to any claim 1, wherein the outer and inner beads present cross-sections of substantially equal area.

6. An annular sealing gasket according to claim 1, wherein at least one of the beads has a cross-section that is partially circular.

7. An annular sealing gasket according to claim 6, wherein said bead has a radius r such that H/4<r<H/8, where H represents the thickness of the gasket in a radial direction of the gasket.

8. An annular sealing gasket according to claim 7, wherein the radius r is substantially equal to ⅙ of the thickness H.

9. An annular sealing gasket according to claim 6, wherein said bead has a radius r such that 6r<L<10r where L represents the thickness of the gasket in an axial direction of the gasket.

10. An annular sealing gasket according to claim 9, wherein the radius r is substantially equal to ⅛ of the thickness L.

11. An annular sealing gasket according to claim 1, wherein the side faces are substantially radial.

12. An annular sealing gasket according to claim 1, having a cross-section that is symmetrical relative to a radial midplane of the gasket.

13. A coupling device for a cylindrical tube, the device including an annular sealing gasket according to claim 1 and having a bore and an abutment against which one of the side faces of the annular sealing gasket comes to bear.

14. A coupling device according to claim 13, wherein the tube is a tube made of plastics material.

15. A coupling device according to claim 13, wherein the frustoconical surface of the inner circumference is shaped to act after insertion of the tube to exert a radial peripheral compression force on the tube.
